(19) United States
(12) Patent Application Publication
(10) Pub. No.: US 2025/0187214 A1
(43) Pub. Date: Jun. 12, 2025

(54) RAIL-TYPE OUT-THE-FRONT FOLDING KNIFE AND USING METHOD THEREOF

(71) Applicant: Zhenglin Chen, Nanning (CN)

(72) Inventor: Zhenglin Chen, Nanning (CN)

(21) Appl. No.: 18/970,830

(22) Filed: Dec. 5, 2024

(30) Foreign Application Priority Data
Dec. 6, 2023 (CN) 202323307995.X

(51) Int. Cl. B26B 1/08; B26B 1/10

(52) U.S. Cl. CPC B26B 1/08; B26B 1/10

(57) ABSTRACT

The present disclosure is in the technical field of folding knives, and particularly relates to a rail-type out-the-front folding knife and a using method thereof. In the present disclosure, the sliding fit between the sliding block and the professional sliding parts of the rail replaces the traditional sliding fit between the knife edge and the knife handle to avoid the friction between the knife edge and the knife handle, making the knife more stable and durable. The sliding block and the rail as components can be replaced and renewed quickly after being worn, making the maintenance more convenient.

### CROSS-REFERENCE TO RELATED APPLICATION

This application claims priority of Chinese Patent Application No. 202323307995.X, filed on Dec. 6, 2023, the entire contents of which are incorporated herein by reference.

### TECHNICAL FIELD

The present disclosure is in the technical field of folding knives, and particularly relates to a rail-type out-the-front folding knife and a using method thereof.

### BACKGROUND

As a common tool in people's daily life, folding knife brings many conveniences for people' s life. Among the folding knife styles available on the market, there is an out-the-front type folding knife, with the knife handle being a box, and the knife edge being completely stored in the knife handle box. When the knife is to be unfolded, the knife edge will pop out from the knife handle box in a linear motion by pushing the switch button forward; and when the knife is to be stored, the knife edge will spring back into the knife handle box in a linear motion by pushing the switch button backward.

The inventor has found in daily work that the out-the-front folding knife generally has a disadvantage that when the knife is used for a certain period of time, the knife edge will be somewhat loose in an unfolded state, because in the design, only a front and rear sliding groove is designed in the knife handle box, allowing the knife edge to slide in the groove. The friction between the knife edge and the groove will cause irreparable wear on the knife and the knife handle, resulting in gap that causes the knife edge to be loose, thus leading to the problem that the knife edge of the existing folding knife is easy to be loose and unstable, and there is no good maintenance method in response to this problem.

### SUMMARY

To overcome the above technical problems, the present disclosure provides a rail-type out-the-front folding knife and a using method thereof. A sliding fit between a sliding block and professional sliding parts of a rail replaces a traditional sliding fit between a knife edge and a knife handle to avoid the friction between the knife edge and the knife handle, making a knife more stable and durable. The sliding block and the rail as components can be replaced and renewed quickly after being worn, making the maintenance more convenient.

The present disclosure adopts the following technical solutions.

A rail-type out-the-front folding knife includes a knife handle and a knife edge which is telescopically arranged back and forth along a length direction. An interior of the knife handle is a cavity, a sliding rail along the length direction is arranged in the cavity, a tail part of the knife edge is connected to a sliding block, and the sliding block is located in the cavity and is slidably connected to the sliding rail; a knife-retracting state limiting mechanism and a knife-extending state limiting mechanism are arranged in the cavity, the sliding block is locked by the knife-retracting state limiting mechanism in a retracting state of a blade, and the sliding block is locked by the knife-extending state limiting mechanism in an extension state of the blade; and a sliding button is slidably arranged outside the knife handle, the sliding button is connected to a power-accumulating ejection mechanism in the cavity via a vertical push rod, and the power-accumulating ejection mechanism drives and connects the sliding block.

In a preferred solution of the present disclosure, the power-accumulating ejection mechanism includes a long strip plate slidably connected to the knife handle along the length direction, and a bottom end of the push rod is fixedly connected to an upper surface of the long strip plate; upper surfaces of front and rear ends of the long strip plate are respectively arranged with a front hook piece and a rear hook piece, a front end of the front hook piece is bent downwards to form a front bent hook, a rear end of the rear hook piece is bent downwards to form a rear bent hook, and the front hook piece and the rear hook piece are connected via a tension spring; and the front bent hook and the rear bent hook clamp the long strip plate due to a tension of the tension spring, and the front bent hook and the rear bent hook extend downward beyond the long strip plate and drive the sliding block.

In a preferred solution of the present disclosure, the rear bent hook abuts against the sliding block forward when the sliding block is located at a rear dead point, an upper surface of the sliding block has a protrusion, and the front bent hook abuts against the protrusion backward when the sliding block is located at a front dead point.

In a preferred solution of the present disclosure, the knife-retracting state limiting mechanism is a pawl piece I located at one side of the sliding rail in a rear half of the knife handle, and a movable end of the pawl piece I faces inward and rearward; the pawl piece I is caught at a front end of the sliding block to prevent the sliding block from moving forward when the sliding block is located at the rear dead point; the knife-extending state limiting mechanism is a pawl piece II located at one side of the sliding rail in a front half of the knife handle, and a movable end of the pawl piece II faces inwards and forwards; and the pawl piece II is caught at a rear end of the sliding block to prevent the sliding block from moving backward when the sliding block is located at the front dead point.

In a preferred solution of the present disclosure, side edge of the long strip plate has an unlocking bump I and an unlocking bump II protruding outwards, a front end of the unlocking bump I is an inclined plane, and a rear end of the unlocking bump II is an inclined plane; in a process that the long strip plate slides forward from the rear dead point, the unlocking bump I pushes the pawl piece I outwards to release a limit of the pawl piece I on the sliding block; and in a process that the long strip plate slides backward from the front dead point, the unlocking bump II pushes the pawl piece II outwards to release a limit of the pawl piece II on the sliding block.

In a preferred solution of the present disclosure, positional relationships of the pawl piece I, the pawl piece II, the unlocking bump I and the unlocking bump II satisfy that: the pawl piece II presses the unlocking bump II backward to prevent the long strip plate from shaking when the long strip plate is located at the rear dead point; and the pawl piece I presses the unlocking bump I forward to prevent the long strip plate from shaking when the long strip plate is located at the front dead point.

In a preferred solution of the present disclosure, the knife handle is divided into a bottom layer plate, an interlayer and a top layer plate, and the cavity is located in a portion of the interlayer; the long strip plate is slidably connected to the interlayer; and the sliding rail is two guide sliding rods fixed to the bottom layer plate along a length direction, and the sliding block is slidably sleeved on the two guide sliding rods.

In a preferred solution of the present disclosure, the front hook piece is disposed with a long sliding groove along the length direction, and the push rod passes through the long sliding groove.

A method of using a switchblade knife, adopting the rail-type out-the-front folding knife, includes the following steps:
knife retraction:
S1, with a knife extended, pushing a sliding button backwards, driving, by the sliding button, a long strip plate to move backwards via a push rod, and driving, by the long strip plate, a rear bent hook to move a rear hook piece backwards, a front hook piece being not moved backwards temporarily because the front hook piece is hooked on a protrusion and a sliding block where the protrusion is located is limited by a pawl piece II, enabling a tension spring to be stretched to store force;
S2, with a backward movement of the long strip plate, allowing an unlocking bump II to reach a pawl piece II and push the pawl piece II outwards by means of an inclined plane, releasing a limitation on the sliding block, and driving the sliding block to slide backwards via a front bent hook by the front hook piece under a tension of the tension spring after the limitation is completely released, allowing a knife edge to be retracted; and
S3, re-limiting and locking the sliding block by a pawl piece I after the sliding block is brought to a rear dead point, keeping the knife retracted, and allowing the long strip plate to not easily slide up due to the pressure from the pawl piece II on an unlocking bump II and the tension of the tension spring; and
knife extension:
S1, with the knife retracted, pushing the sliding button forwards, driving, by the sliding button, the long strip plate to move forwards via the push rod, and driving, by the long strip plate, the front bent hook to move the front hook piece forwards, the rear hook piece being not moved forwards temporarily because the rear hook piece is hooked on the sliding block and the sliding block is limited by the pawl piece I, enabling the tension spring to be stretched to store force;
S2, with a forward movement of the long strip plate, allowing an unlocking bump I to reach the pawl piece I and push the pawl piece I outwards by means of the inclined plane, releasing the limitation on the sliding block, and driving the sliding block to slide forwards via the rear bent hook by the rear hook piece under the tension of the tension spring after the limitation is completely released, allowing the knife edge to be extended; and
S3, re-limiting and locking the sliding block by the pawl piece II after the sliding block is brought to a front dead point, keeping the blade extended, and allowing the long plate to not easily slide down due to the pressure from the pawl piece I on the unlocking bump I and the tension of the tension spring.

Compared with the prior art, the present disclosure has the following advantageous effects.
1. In the present disclosure, the sliding fit between the sliding block and the professional sliding parts of the rail replaces the traditional sliding fit between the knife edge and the knife handle to avoid the friction between the knife edge and the knife handle, making the knife more stable and durable. The sliding block and the rail as components can be replaced and renewed quickly after being worn, making the maintenance more convenient.
2. In the present disclosure, structures such as the long strip plate, the front hook piece, the rear hook piece and a spring are arranged to form a force-accumulating ejection mechanism for the sliding block, and the pawl piece I and the pawl piece II are arranged to limit and lock the back dead point and the front dead point of the sliding block; and in a locked state, the long strip plate is also pressed by the pawl pieces, which has a certain limiting effect, thereby ensuring that the long strip plate and the sliding button will not shake and the knife structure is more stable.

### BRIEF DESCRIPTION OF THE DRAWINGS

FIG. 1 is an overall schematic view of the present disclosure;

FIG. 2 is a schematic view of an internal structure of FIG. 1 after a sliding button, an interlayer and a top layer plate are removed;

FIG. 3 is a top view of FIG. 2;

FIG. 4 is a side view of FIG. 2;

FIG. 5 is a schematic structural view of FIG. 2 after a power-accumulating ejection mechanism, a pawl plate I and a pawl plate II are removed; and

FIG. 6 is a schematic view of an internal structure of the present disclosure when the knife is retracted.

### REFERENCE NUMERALS AND DENOTATIONS THEREOF

1-knife edge; 2-knife handle; 21-bottom layer plate; 22-interlayer; 23-top layer plate; 3-sliding button; 31-push rod; 4-power-accumulating ejection mechanism; 41-long strip plate; 411-unlocking bump I; 412-unlocking bump II; 42-tension spring; 43-front hook piece; 431-front bent hook; 44-rear hook piece; 441-rear bent hook; 5-sliding rail; 51-sliding block; 511-protrusion; 6-pawl piece I; and 7-pawl piece II.

### DETAILED DESCRIPTION

Examples of the present disclosure are described in detail below, and the examples of which are shown in the accompanying drawings. The same or similar designations throughout indicate the same or similar elements or elements with the same or similar functions. Unless otherwise specified, the raw materials and devices used are commercially available or commonly used in the art, and the methods in the examples, unless otherwise specified, are the conventional methods in the art. The examples described below with reference to the accompanying drawings are illustrative only and are not to be construed as limiting the present disclosure.

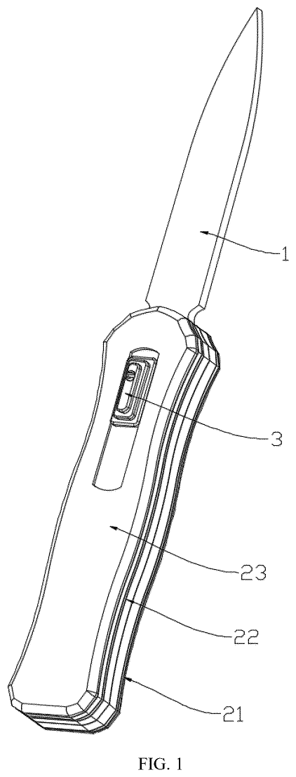

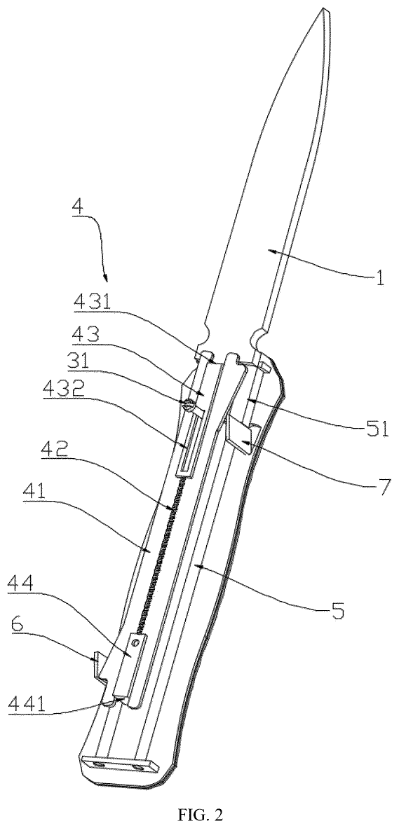

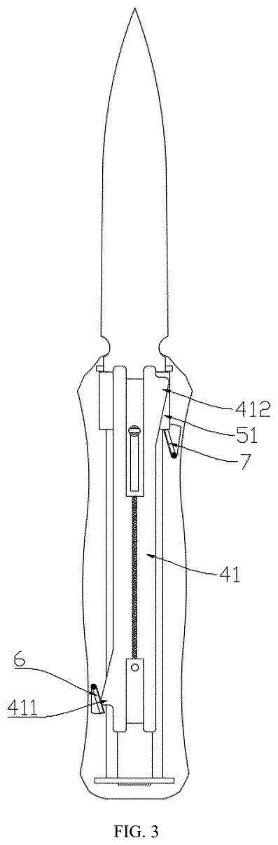

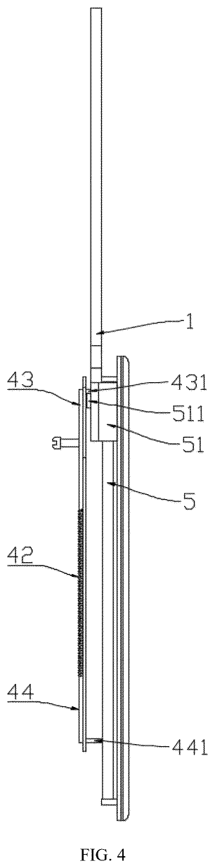

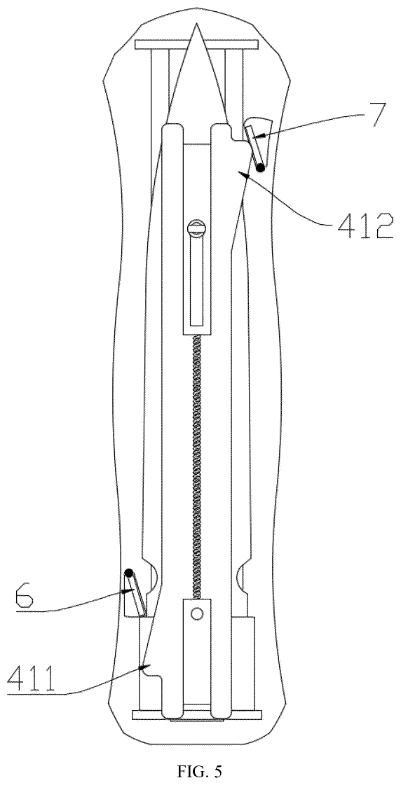

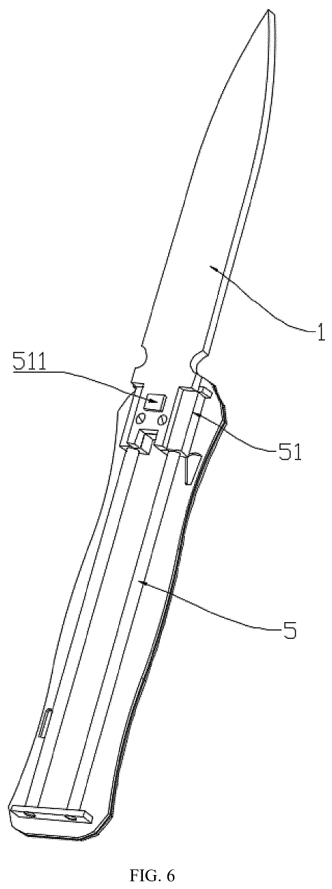

Referring to FIGS. 1-6, a rail-type out-the-front folding knife includes a knife handle 2 and a knife edge 1 which is telescopically arranged back and forth along a length direction. An interior of the knife handle 2 is a cavity, the knife handle 2 is divided into a bottom layer plate 21, an interlayer 22 and a top layer plate 23, and the cavity is located in a portion of the interlayer 22. A sliding rail 5 along the length direction is arranged in the cavity, a tail part of the knife edge 1 is connected to a sliding block 51, and the sliding block 51 is located in the cavity and is slidably connected to the sliding rail 5. The sliding rail 5 is two guide sliding rods fixed to the bottom layer plate 21 along a length direction, and the sliding block 51 is slidably sleeved on the two guide sliding rods. A knife-retracting state limiting mechanism and a knife-extending state limiting mechanism are arranged in the cavity, the sliding block 51 is locked by the knife-retracting state limiting mechanism in a retracting state of a blade, and the sliding block 51 is locked by the knife-extending state limiting mechanism in an extension state of the blade. A sliding button 3 is slidably arranged outside the knife handle 2, the sliding button 3 is connected to a power-accumulating ejection mechanism 4 in the cavity via a vertical push rod 31, and the power-accumulating ejection mechanism 4 drives and connects the sliding block 51. Specifically, the power-accumulating ejection mechanism 4 includes a long strip plate 41 slidably connected to the knife handle 2 along the length direction. The long strip plate 41 is slidably connected to the interlayer 22, a bottom end of the push rod 31 is fixedly connected to an upper surface of the long strip plate 41. Upper surfaces of front and rear ends of the long strip plate 41 are respectively arranged with a front hook piece 43 and a rear hook piece 44. The front hook piece 43 is disposed with a long sliding groove along the length direction, and the push rod 31 passes through the long sliding groove. A front end of the front hook piece 43 is bent downwards to form a front bent hook 431, a rear end of the rear hook piece 44 is bent downwards to form a rear bent hook 441, and the front hook piece 43 and the rear hook piece 44 are connected via a tension spring 42. The front bent hook 431 and the rear bent hook 441 clamp the long strip plate 41 due to a tension of the tension spring 42, and the front bent hook 431 and the rear bent hook 441 extend downward beyond the long strip plate 41. The rear bent hook 441 abuts against the sliding block 51 forward when the sliding block 51 is located at a rear dead point. An upper surface of the sliding block 51 has a protrusion 511, and the front bent hook 431 abuts against the protrusion 511 backward when the sliding block 51 is located at a front dead point. The protrusion 511 is also one of connectors of the sliding block 51 and the knife edge 1. An opening is disposed at a tail of the knife edge 1, the opening is engaged with the protrusion 511, the opening is mounted in alignment with the protrusion 511, and the knife edge 1 is fixed to the sliding block 51 using a screw.

The knife-retracting state limiting mechanism is a pawl piece I 6 located at one side of the sliding rail 5 in a rear half of the knife handle 2, and a movable end of the pawl piece I 6 faces inward and rearward. The pawl piece I 6 is caught at a front end of the sliding block 51 to prevent the sliding block 51 from moving forward when the sliding block 51 is located at the rear dead point. The knife-extending state limiting mechanism is a pawl piece II 7 located at one side of the sliding rail 5 in a front half of the knife handle 2, and a movable end of the pawl piece II 7 faces inwards and forwards. The pawl piece II 7 is caught at a rear end of the sliding block 51 to prevent the sliding block 51 from moving backward when the sliding block 51 is located at the front dead point.

A side edge of the long strip plate 41 has an unlocking bump I 411 and an unlocking bump II 412 protruding outwards, a front end of the unlocking bump I 411 is an inclined plane, and a rear end of the unlocking bump II 412 is an inclined plane. In a process that the long strip plate 41 slides forward from the rear dead point, the unlocking bump I 411 pushes the pawl piece I 6 outwards, thereby releasing a limit of the pawl piece I 6 on the sliding block 51; and in a process that the long strip plate 41 slides backward from the front dead point, the unlocking bump II 412 pushes the pawl piece II 7 outwards, thereby releasing a limit of the pawl piece II 7 on the sliding block 51. Positional relationships of the pawl piece I 6, the pawl piece II 7, the unlocking bump I 411 and the unlocking bump II 412 satisfy that: the pawl piece II 7 presses the unlocking bump II 412 backward to prevent the long strip plate 41 from shaking when the long strip plate 41 is located at the rear dead point; and the pawl piece I 6 presses the unlocking bump I 411 forward to prevent the long strip plate 41 from shaking when the long strip plate 41 is located at the front dead point.

It is to be noted that the above embodiments are only specific and clear descriptions on the technical solutions and technical features of the present application. However, for a person skilled in the art, solutions or features which fall within the prior art or common knowledge are not described in detail in the above embodiments.

In addition, the technical solutions of the present application are not limited to the above embodiments, and a person skilled in the art would have considered the specification as a whole. The technical solutions in the various embodiments can also be combined appropriately to form other implementations which can be understood by a person skilled in the art.

While embodiments of the present disclosure have been shown and described, it will be appreciated by those skilled in the art that many changes, modifications, substitutions and variations can be made to the above embodiments without departing from the principles and spirit of the present disclosure, the scope of which is defined by the claims and equivalents thereof.

1. A rail-type out-the-front folding knife, comprising a knife handle (2) and a knife edge (1) which is telescopically arranged back and forth along a length direction, wherein an interior of the knife handle (2) is a cavity, a sliding rail (5) along the length direction is arranged in the cavity, a tail part of the knife edge (1) is connected to a sliding block (51), and the sliding block (51) is located in the cavity and is slidably connected to the sliding rail (5); a knife-retracting state limiting mechanism and a knife-extending state limiting mechanism are arranged in the cavity, the sliding block (51) is locked by the knife-retracting state limiting mechanism in a retracting state of a blade, and the sliding block (51) is locked by the knife-extending state limiting mechanism in an extension state of the blade; and a sliding button (3) is slidably arranged outside the knife handle (2), the sliding button (3) is connected to a power-accumulating ejection mechanism (4) in the cavity via a vertical push rod (31), and the power-accumulating ejection mechanism (4) drives and connects the sliding block (51).

2. The rail-type out-the-front folding knife according to claim 1, wherein the power-accumulating ejection mechanism (4) comprises a long strip plate (41) slidably connected to the knife handle (2) along the length direction, and a bottom end of the push rod (31) is fixedly connected to an upper surface of the long strip plate (41); upper surfaces of front and rear ends of the long strip plate (41) are respectively arranged with a front hook piece (43) and a rear hook piece (44), a front end of the front hook piece (43) is bent downwards to form a front bent hook (431), a rear end of the rear hook piece (44) is bent downwards to form a rear bent hook (441), and the front hook piece (43) and the rear hook piece (44) are connected via a tension spring (42); and the front bent hook (431) and the rear bent hook (441) clamp the long strip plate (41) due to a tension of the tension spring (42), and the front bent hook (431) and the rear bent hook (441) extend downward beyond the long strip plate (41) and drive the sliding block (51).

3. The rail-type out-the-front folding knife according to claim 2, wherein the rear bent hook (441) abuts against the sliding block (51) forward when the sliding block (51) is located at a rear dead point, an upper surface of the sliding block (51) has a protrusion (511), and the front bent hook (431) abuts against the protrusion (511) backward when the sliding block (51) is located at a front dead point.

4. The rail-type out-the-front folding knife according to claim 3, wherein the knife-retracting state limiting mechanism is a pawl piece I (6) located at one side of the sliding rail (5) in a rear half of the knife handle (2), and a movable end of the pawl piece I (6) faces inward and rearward; the pawl piece I (6) is caught at a front end of the sliding block (51) to prevent the sliding block (51) from moving forward when the sliding block (51) is located at the rear dead point; the knife-extending state limiting mechanism is a pawl piece II (7) located at one side of the sliding rail (5) in a front half of the knife handle (2), and a movable end of the pawl piece II (7) faces inwards and forwards; and the pawl piece II (7) is caught at a rear end of the sliding block (51) to prevent the sliding block (51) from moving backward when the sliding block (51) is located at the front dead point.

5. The rail-type out-the-front folding knife according to claim 4, wherein side edge of the long strip plate (41) has an unlocking bump I (411) and an unlocking bump II (412) protruding outwards, a front end of the unlocking bump I (411) is an inclined plane, and a rear end of the unlocking bump II (412) is an inclined plane; in a process that the long strip plate (41) slides forward from the rear dead point, the unlocking bump I (411) pushes the pawl piece I (6) outwards to release a limit of the pawl piece I (6) on the sliding block (51); and in a process that the long strip plate (41) slides backward from the front dead point, the unlocking bump II (412) pushes the pawl piece II (7) outwards to release a limit of the pawl piece II (7) on the sliding block (51).

6. The rail-type out-the-front folding knife according to claim 5, wherein positional relationships of the pawl piece I (6), the pawl piece II (7), the unlocking bump I (411) and the unlocking bump II (412) satisfy that: the pawl piece II (7) presses the unlocking bump II (412) backward to prevent the long strip plate (41) from shaking when the long strip plate (41) is located at the rear dead point; and the pawl piece I (6) presses the unlocking bump I (411) forward to prevent the long strip plate (41) from shaking when the long strip plate (41) is located at the front dead point.

7. The rail-type out-the-front folding knife according to claim 6, wherein the knife handle (2) is divided into a bottom layer plate (21), an interlayer (22) and a top layer plate (23), and the cavity is located in a portion of the interlayer (22); the long strip plate (41) is slidably connected to the interlayer (22); and the sliding rail (5) is two guide sliding rods fixed to the bottom layer plate (21) along a length direction, and the sliding block (51) is slidably sleeved on the two guide sliding rods.

8. The rail-type out-the-front folding knife according to claim 1, wherein the front hook piece (43) is disposed with a long sliding groove along the length direction, and the push rod (31) passes through the long sliding groove.

9. A method of using a switchblade knife, adopting the rail-type out-the-front folding knife according to claim 7, comprising the following steps:
knife retraction:
S1, with a knife extended, pushing a sliding button (3) backwards, driving, by the sliding button (3), a long strip plate (41) to move backwards via a push rod (31), and driving, by the long strip plate (41), a rear bent hook (441) to move a rear hook piece (44) backwards, a front hook piece (43) being not moved backwards temporarily because the front hook piece (43) is hooked on a protrusion (511) and a sliding block (51) where the protrusion (511) is located is limited by a pawl piece II (7), enabling a tension spring (42) to be stretched to store force;
S2, with a backward movement of the long strip plate (41), allowing an unlocking bump II (412) to reach a pawl piece II (7) and push the pawl piece II (7) outwards by means of an inclined plane, releasing a limitation on the sliding block (51), and driving the sliding block (51) to slide backwards via a front bent hook (431) by the front hook piece (43) under a tension of the tension spring (42) after the limitation is completely released, allowing a knife edge (1) to be retracted; and
S3, re-limiting and locking the sliding block (51) by a pawl piece I (6) after the sliding block (51) is brought to a rear dead point, keeping the knife retracted, and allowing the long strip plate (41) to not easily slide up due to the pressure from the pawl piece II (7) on an unlocking bump II (412) and the tension of the tension spring (42); and
knife extension:
S1, with the knife retracted, pushing the sliding button (3) forwards, driving, by the sliding button (3), the long strip plate (41) to move forwards via the push rod (31), and driving, by the long strip plate (41), the front bent hook (431) to move the front hook piece (43) forwards, the rear hook piece (44) being not moved forwards temporarily because the rear hook piece (44) is hooked on the sliding block (51) and the sliding block (51) is limited by the pawl piece I (6), enabling the tension spring (42) to be stretched to store force;
S2, with a forward movement of the long strip plate (41), allowing an unlocking bump I (411) to reach the pawl piece I (6) and push the pawl piece I (6) outwards by means of the inclined plane, releasing the limitation on the sliding block (51), and driving the sliding block (51) to slide forwards via the rear bent hook (441) by the rear hook piece (44) under the tension of the tension spring (42) after the limitation is completely released, allowing the knife edge (1) to be extended; and
S3, re-limiting and locking the sliding block (51) by the pawl piece II (6) after the sliding block (51) is brought to a front dead point, keeping the blade (1) extended, and allowing the long plate (41) to not easily slide down due to the pressure from the pawl piece I (6) on the unlocking bump I (411) and the tension of the tension spring (42).
